(19) United States
(12) Patent Application Publication
(10) Pub. No.: US 2021/0112345 A1
(43) Pub. Date: Apr. 15, 2021

(54) HEARING AID WITH INERTIAL MEASUREMENT UNIT

(71) Applicant: WIDEX A/S, Lynge (DK)

(72) Inventors: Peter Alan WOOD, Lynge (DK); Johan Myhre ANDERSEN, Lynge (DK); Caspar Aleksander Bang JESPERSEN, Lynge (DK); Jannik ANDERSEN, Lynge (DK); Jacob Thorup HALD, Lynge (DK)

(73) Assignee: WIDEX A/S, Lynge (DK)

(21) Appl. No.: 17/051,880

(22) PCT Filed: May 3, 2018
(86) PCT No.: PCT/EP2018/061346

§ 371 Date: Oct. 30, 2020

(51) Int. Cl. H04R 25/00

(52) U.S. Cl. CPC H04R 25/305; H04R 25/55; H04R 2460/03; H04R 2225/61; H04R 25/45

(57) ABSTRACT

A hearing aid (1) comprises a hearing aid, a processor (7) and an inertial measurement unit (12), the processor being adapted to utilize the output from the inertial measurement unit to derive information about at least one of motion, tilt, and posture. The invention further provides a method of deriving information about at least one of motion, tilt, and posture.

### FIELD OF THE INVENTION

The present invention relates to a hearing aid with inertial measurement unit. The invention further relates to a method of deriving motion by a hearing aid.

### BACKGROUND OF THE INVENTION

### 1. Field of the Invention

Within the context of the present disclosure a hearing aid can be understood as a small, battery-powered, microelectronic device designed to be worn behind or in the human ear by a hearing-impaired user. Prior to use, the hearing aid is adjusted by a hearing aid fitter according to a prescription. The prescription is based on a hearing test, the result of which is expressed in an audiogram depicting the performance of the hearing-impaired user's unaided hearing. The prescription is developed to reach a setting where the hearing aid will alleviate a hearing loss by amplifying sound at frequencies in those parts of the audible frequency range where the user suffers a hearing deficit. A hearing aid comprises one or more microphones, a battery, a microelectronic circuit comprising a signal processor adapted to provide amplification tailored to meet the needs of the user, and an acoustic output transducer (in the hearing aid parlance often referred to as the receiver). The signal processor is preferably a digital signal processor.

The hearing aid is enclosed in a casing suitable for fitting behind or in a human ear. The hearing aid has an ear piece part adapted for fitting inside the mouth of the ear canal and sealing acoustically against the ear canal wall, in order to provide some sound insulation between the volume in the inner part of the ear canal to which the acoustic output is delivered and the surroundings. The ear piece part may contain the complete hearing aid, as in types designated ITE (In-The-Ear) or CIC (Completely-In-Canal) hearing aids, or it may contain a portion, above all the acoustic output conduit, while relegating the other components to a housing adapted for placement behind the exterior ear, as in types designated BTE (Behind-The-Ear) hearing aids.

High-end hearing aids come with a selection of user programs, developed to cater for special conditions (conditions of noise, wind, telephone answering, music listening) and to target different priorities (enhancing speech intelligibility). User programs may be preselected during the fitting process, or they may be selected on the fly by the user by means of a button or a remote control.

Top-notch hearing aids come with wireless capabilities for linking up to another hearing aid, a remote control, a streamer or a mobile phone, for purposes of selecting among user programs, streaming sound, synchronizing settings among a pair of hearing aids, uploading data to the remote control or the mobile phone etc.

Within the present context a hearing aid system may comprise a single hearing aid (a so called monaural hearing aid system) or two hearing aids, one for each ear of the hearing aid user (referred to as a binaural hearing aid system). Furthermore the hearing aid system may comprise an external device, such as a smart phone, smart watch, or other wearable device having software applications adapted to interact with other devices of the hearing aid system. Thus within the present context the term “hearing aid system device” may denote a hearing aid or an external device.

Generally a hearing aid system according to the invention is understood as meaning any system which provides an output signal that can be perceived as an acoustic signal by a user, or contributes to providing such an output signal, and which has means operational to compensate for an individual hearing loss of the user or to contribute to compensating for the hearing loss of the user. These systems may comprise hearing aids which can be worn on the body or on the head, in particular on or in the ear, and can be fully or partially implanted. Within the context of the present disclosure, some devices whose main aim is not to compensate for a hearing loss but have hearing loss compensation capabilities may also be considered hearing aid systems, for example consumer electronic devices (televisions, hi-fi systems, mobile phones, MP3 players etc.)

### 2. The Prior Art

US-A1-20090257608 provides a hearing aid with an accelerometer, an electrical circuit, and a memory. The accelerometer generates an electrical signal in dependence on an acceleration of the hearing aid. The signal is used to determine a case of a jerky acceleration as might happen if the hearing aid is dropped. After a drop the hearing aid settings can be reconstructed from the memory so that as a result this prevents the settings of the hearing aid from being changed due to the impact.

US-B2-7295676 provides a hearing aid with an accelerometer for determining the position of the users head.

US-A1-20090097683 provides a hearing aid with an accelerometer for use as a pedometer, to determine head tilt to adjust head related transfer functions, or to notify that the user has fallen or is falling asleep.

U.S. Pat. No. 6,072,884 provides a hearing aid with a feedback cancellation circuit comprising an adaptive filter, such as an IIR filter. The filter coefficients are developed during start-up.

WO-A1-2010138520 provides a motion state aware headset, which determines whether the headset is not in use by indicating when the headset has been immobile for a preset period. If that is the case, the high power processor is placed in deep sleep mode.

A state of the art mobile telephone comes with a range of motion-related sensors, including accelerometer, magnetometer, tilt sensor and GPS receiver (Global Positioning System receiver). These sensors employ MEMS (Micro Electro Mechanical Systems).

Literally the term accelerometer signifies a device for picking up acceleration. However, within the field of micro-electronic mechanical sensors, the term accelerometer is often used in a broad sense encompassing a range of devices for sensing motion, location, gravity or spatial orientation. Manufacturers offer tri-axis accelerometers (a set of three accelerometers in an x-y-z arrangement), six-axis accelerometers (tri-axis accelerometer together with a tri-axial arrangement of rotation sensors) or accelerometers for determining directions (e.g. magnetometers or gravity sensors). MEMS-accelerometers nowadays are available in an integrated package complete with A/D converters, three- or six-axis devices, magnetometers, and other sensors like temperature sensors, and integrated processors with software.

Within the body of the present disclosure, the term accelerometer should understood in a broad sense, in line with this tradition, i.e. where not otherwise explained an accelerometer is understood as encompassing all these types of sensors.

Some hearing aids are adapted for playing a welcome message once the hearing aid has been switched on, typically after a delay timed to allow the user time to insert the hearing aid in the ear canal. The message provides audible indication that the hearing aid is switched on.

For a hearing aid user, the process of putting on the hearing aids typically involves switching them on, inserting the ear piece part in the mouth of the ear canal, and placing any housing over the exterior part of the ear. The correct positioning may be difficult to some users, and actually the time taken to complete the insertion may vary widely among users and from time to time. Therefore a fixed delay to allow for the insertion before the hearing aid conducts a feedback test and plays a welcome message may not cater to the requirements of all users to all times.

In case the user has a set of two hearing aids, they will normally be handled one at a time. Once a hearing aid is correctly placed, with the ear piece part seated tight in the ear canal, the ear canal wall provides some acoustic insulation between the sound output and the sound input. As the spacing between input and output at the hearing aid is short, and as the hearing aid amplifies the sound, the output sound might feed back to the sound input. This can easily reach an instable situation where the hearing aid whistles. Normally the hearing aid will be adjusted to cap the gain to a level below the threshold of stability, while the hearing aid is in the use position. However, operation of the power switch, whether by manipulation or by the action of a motion sensor, usually takes place with the hearing aid in the hand. Meanwhile the hearing aid is deprived of the sound insulation normally provided by the seating in the ear canal, and will therefore in many cases whistle until it reaches the intended proper seat in the ear canal.

### SUMMARY OF THE INVENTION

The invention, in a first aspect, provides a hearing aid according to claim 1.

This provides a hearing aid with capabilities for deriving information about motion, tilt, and posture. This may be used to ensure that a welcome message is played at a suitable time, whether the user is quick or slow to complete the insertion operation. Further, it may be used to mute the hearing aid for as long as it is outside the ear canal, thereby preventing the hearing aid from whistling while deprived of the sound insulation by the ear canal. Further it may be used to ensure that a start up test can be conducted only once the hearing aid has been properly inserted.

Tracking the movement of putting on hearing aids by means of an accelerometer permits achieving effects as follows:

a) The hearing aid can be muted to suppress feedback howling while not enjoying the sound separation between speaker and mike otherwise provided by the ear canal

b) A welcome message can be played at the proper time when the hearing aid, or both of two hearing aids, have been correctly inserted

c) A feedback test and adaptation to optimize feedback cancellation can get a run at the proper time while enjoying the sound separation between speaker and mike provided by the ear canal

The invention, in a second aspect, provides a hearing aid system, comprising a hearing aid and an external device as recited in claim 9.

The invention, in a third aspect, provides a method as recited in claim 10.

Further advantageous features appear from the dependent claims.

Still other objects of the present invention will become apparent to those skilled in the art from the following description wherein the invention will be explained in greater detail.

### BRIEF DESCRIPTION OF THE DRAWINGS

By way of example, there is shown and described a preferred embodiment of this invention. As will be realized, the invention is capable of other different embodiments, and its several details are capable of modification in various, obvious aspects, all without departing from the invention. Accordingly, the drawings and descriptions will be regarded as illustrative in nature and not as restrictive. In the drawings:

FIG. 1 illustrates a part of a hearing aid, in longitudinal vertical section;

FIG. 2 illustrates a the part of the hearing aid of FIG. 1, in top plan view;

FIG. 3 illustrates a block diagram of a hearing aid and a mobile phone;

FIG. 4 illustrates a more detailed block schematic diagram of a hearing aid and a mobile phone;

FIG. 5 illustrates a view of a pair of hearing aids and a mobile phone;

FIG. 6 is a perspective of a hearing aid with illustration of the axes for describing attitude and rotation;

FIG. 7 illustrates hearing aids in a posture as during normal use and in postures as might occur during manipulation;

FIG. 8 is a block diagram illustrating processing to calculate motion; and

FIG. 9 illustrates a set-up for fitting a hearing aid.

### DETAILED DESCRIPTION

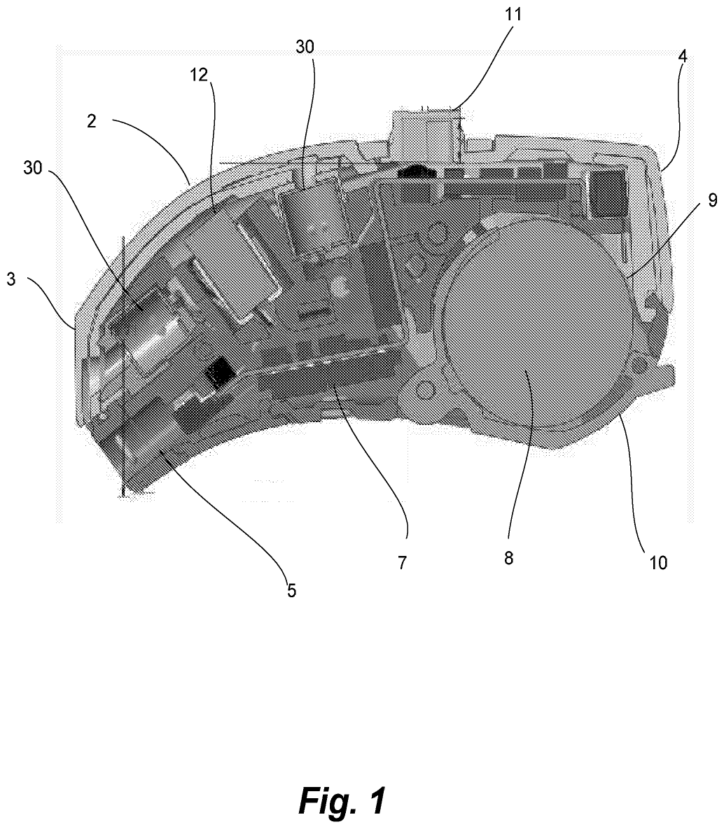

Reference is first made to FIG. 1, which illustrates a hearing aid housing 2, front face of housing 3, rear face of housing 4, electronics module 7, battery 8, battery compartment 9, battery door 10 and program button 11. The battery door can be opened to permit replacement of the battery, or it can be just partially opened to interrupt the power to the processor, acting in this ways as a power switch.

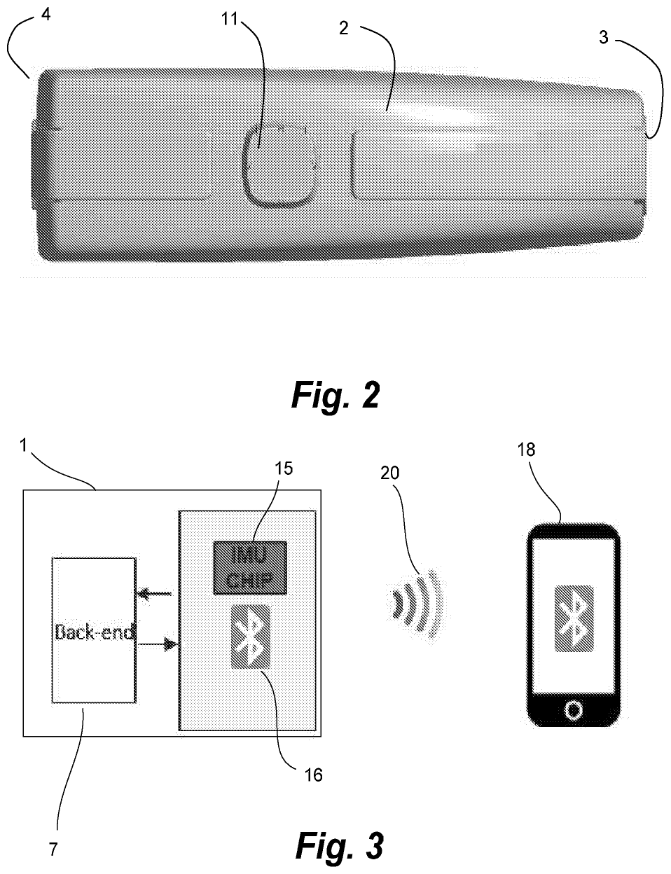

Secondly, reference is made to FIG. 2, which depicts part of the hearing aid of FIG. 1, in top plan view, showing housing 2, housing front face 3, housing rear face 4 and user button 11.

Reference is made to FIG. 3, which symbolically shows a block diagram of a hearing aid 1 with the IMU (inertial measurement unit) chip 15, processor backend (electronics module) 7, Bluetooth block 16, and mobile phone 18 with a Bluetooth capability. These blocks interact in the way that the IMU block or chip processes signals from the accelerometer (shown in FIG. 1) and forwards an input to the electronics module, which receives information from other circuits, e.g. microphone, radio receiver etc., and works out when to act. When action is deemed appropriate a message is transmitted by the short-range radio link 20 to the mobile phone 18, e.g. Bluetooth or another near-field radio link.

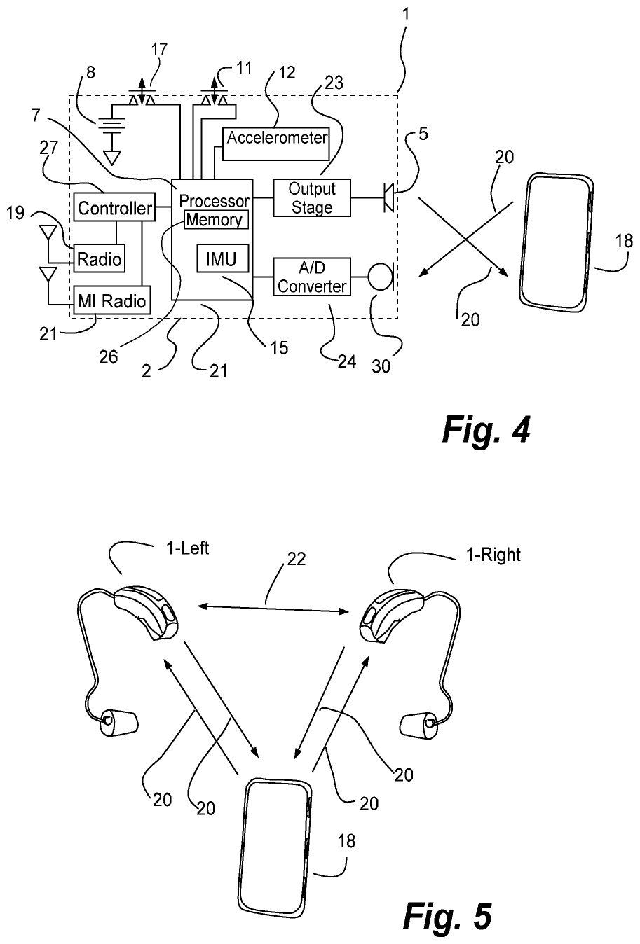

Reference is then made to FIG. 4, which shows a block diagram of a hearing aid and a mobile phone 18, in greater detail. FIG. 4 shows hearing aid 1, comprising microphone 30, power switch 17, processor in the form of electronics circuit 7, battery 8, button 11, accelerometer 12, radio controller 13, IMU block 15, short range radio 19, short range radio link 20, magnetic induction radio 21, A/D input converter 24 for the microphone input, output stage 23 for driving the speaker 5, and processor memory 26. The hearing aid 1 communicates with the mobile phone via a short-range radio link 20, e.g. Bluetooth or another near-field radio link.

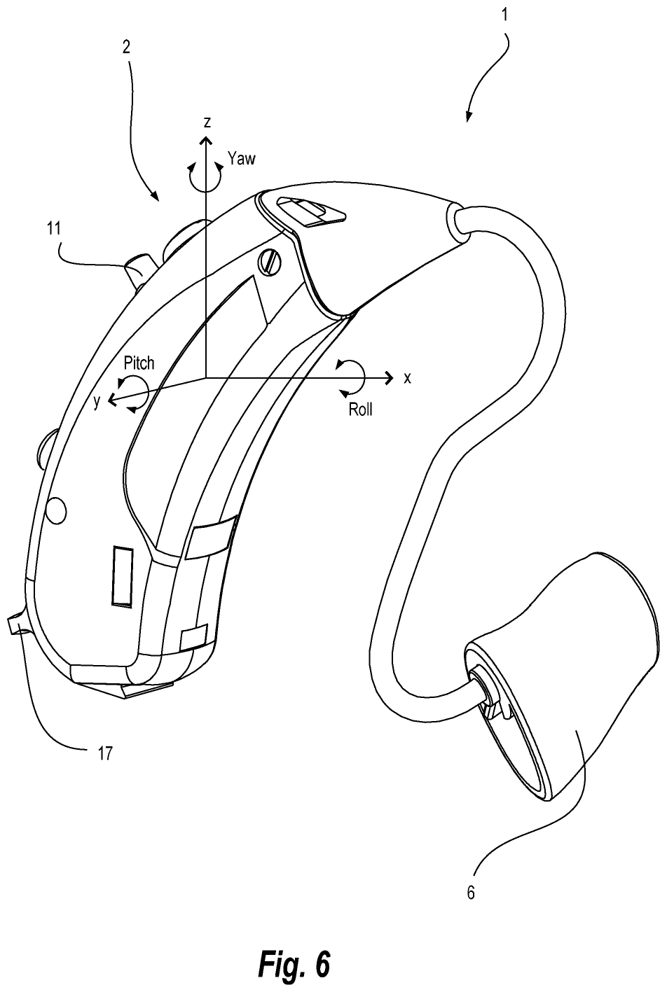

Reference is next made to FIG. 5, which illustrates a pair of hearing aids designated 1-Left and 1-Right and mobile phone 18. The hearing aids are interconnected by an inductive link 22. Each of the hearing aids is connected to the mobile phone 18 by a short range radio link 20.

Reference is now made to FIG. 6, which depicts a perspective view of a BTE hearing aid in upright position as in normal usage. The geometrical axes for describing the motion are indicated. The system of coordinates is laid out referring to the attitude in normal usage position, i.e. the x-axis pointing forwards (the user is assumed to look forwards), the y-axis pointing to one side, and the z-axis pointing upwards. The rotary motions around the respective axes are referred as roll, pitch and yaw, as normally used in the art of navigation.

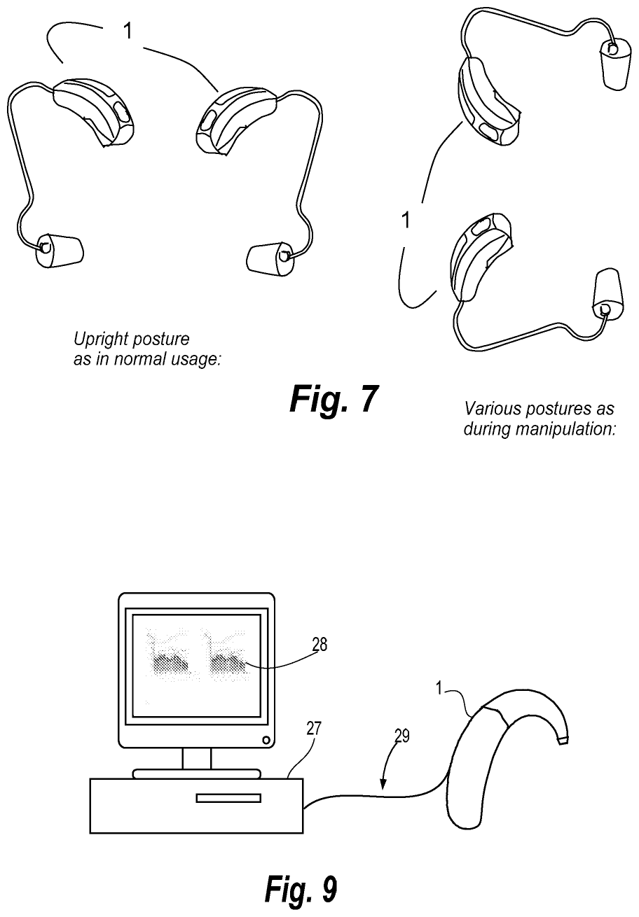

Reference in next made to FIG. 7, which depicts in the upper part a pair of hearing aids in the positions and attitudes as during normal wear, and, in the lower part, two examples of attitudes that could be attained during manipulation of the hearing aids, while they are less likely to be attained during normal usage.

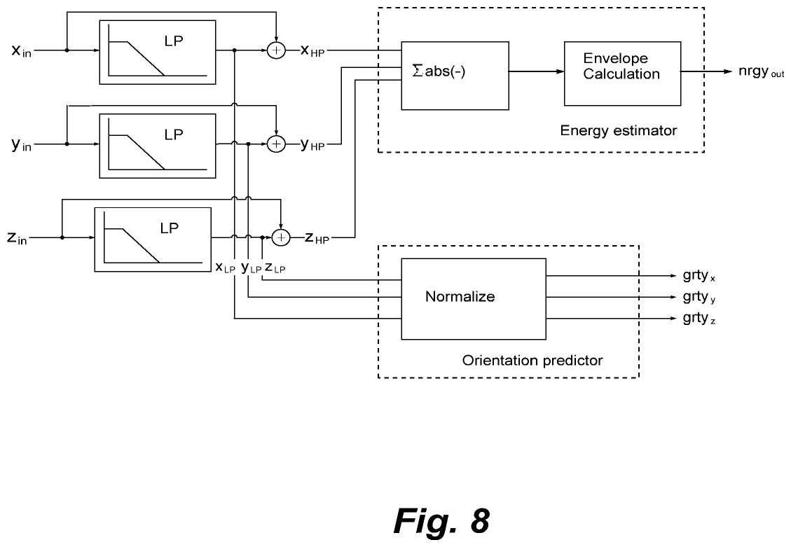

Reference is made to FIG. 8, which is a block diagram showing how inputs from the channels of a triaxial accelerometer will be normalized and analyzed to compute the motion and the orientation. Low-frequency filtering may be applied and absolute values and envelopes may be computed. Low frequency filtering suppresses various erratic spike signals, e.g. due to accidentally hitting the hearing aid by the hand, and helps developing the trends. The same principle is used in the case of inputs from rotation sensors, tilt sensors and magnetometer sensors. Suitable software is available from manufacturers of accelerometers, in many cases included on the chip. Time series analysis of inputs from various sensors about motion to develop a trajectory and estimate current track and attitude is done using methods developed in the science of navigation. Reference may e.g. be had to
Paul Zarchan; Howard Musoff (2000). Fundamentals of Kalman Filtering: A Practical Approach. American Institute of Aeronautics and Astronautics, Incorporated. ISBN 978-1-56347-455-2, available at https://en.wikipedia.org/wiki/Kalman_filter
Understanding the Basis of the Kalman Filter via a Simple and Intuitive Derivation [Lecture Notes] R. Faragher. Signal Processing Magazine, IEEE, vol. 29, no. 5, pp. 128-132, September 2012 doi: 10.1109/MSP.2012.2203621, available at https://www.cl.cam.ac.uk˜rmf25/papers/
The Unscented Kalman Filter for Nonlinear Estimation. Conference Paper (PDF Available)⋅February 2000?with?1,381 Reads DOI: 10.1109/ASSPCC.2000.882463⋅Source: IEEE Xplore,
available at https://www.researchgate.net/publication/3873439
Conference: Adaptive Systems for Signal Processing, Communications, and Control Symposium 2000. AS-SPCC. The IEEE 2000
More references may be found at https://www.cl.cam.ac.uk/˜rmf25/papers/Understanding%20the%20Basis%20of%20the%20Kalman%20Filter.pdf

Reference is now made to FIG. 9, which shows a setup for fitting the hearing aid 1. The equipment comprises a computer 27 with monitor 28 and connection 29 (by cable or by radio link) to the hearing aid 1. The computer executes fitting software, which can be based on a standard software, enhanced with particular features relating to the measurements and loggings of accelerometer measurements, and appropriate program options. Data as detected by the motion sensors and the messages generated in the hearing aids may be uploaded to the computer and displayed for the fitter and for the user.

Controlling and Usage of Hearing Aids

Howl Suppression

As the hearing aids are normally switched on and off by a manipulation as part of the operation of removal or insertion of hearing aids to the user's ears, i.e. while not placed at the ears, there is an interval wherein the respective acoustic feedback paths from the receiver to the microphone are not obstructed, which makes the devices prone to produce an annoying howling sound due to unstable feedback. In one embodiment, accelerometer data, possibly combined with microphone data, is utilized to determine whether the hearing aid is in a phase of being removed, applied or neither (e.g. left lying on a table), in order that the processor can act to suppress the gain, turn off the receiver, or turn off the microphone to prevent the howling effect.

Behind-the-Scenes Features

Automatic Power Down

Many hearing aids are adapted to be turned off through partial opening the battery door. However, even when the door is opened, the normal types of batteries will still exhibit a slow loss of charge, normally expressed in terms of a leak current, typically amounting to around 50 μA, whereas normal operation uses around 1 mA=1000 μA. The leak current can be reduced, if not completely removed, by drawing an amount of current from it.

It would be feasible to be able to detect periods of time, where the hearing aid is not being used, and then automatically switch the hearing aid from an operational mode into a low-power mode, where parts of the circuitry are inactive. Through appropriate design of the processor circuit (e.g. selecting a power-effective processor technology, dividing the processor up in subsections that can be selectively turned off, assigning the bare minimum number of operations to a subsection adapted to be always on, etc.), it is estimated that an ultra-low power mode can be achieved, wherein the consumption of current can be brought down to a level approaching the leak current. An accelerometer and the associated preamplifier and processor parts can be designed for very low power consumption, suitable for including them among the always-on parts of the circuitry. This permits using the accelerometer to detect motion of the hearing aid in order to determine whether the hearing aid is in use or removed (e.g. placed on a table), in order that the processor can power-down when not in use, and can resume normal operation whenever the hearing aid is mounted again. In this way power switching is effectively automatic.

In one embodiment, the processor is adapted to power-down on detecting that the hearing aid is lying on the side. This is convenient, as a BTE-hearing aid laid down on a table would by itself come to rest on one side, which is an orientation rarely occurring during actual usage. The power-down state of the processor will often be referred as a power-off state, although, strictly speaking, only part of the processor is off, while there remains an always-on part, which is responsible for handling wake-up calls and turning on the remaining part.

Another embodiment employs an inter-ear radio communication link between two hearing aids, enabling each of the hearing aids to distinguish between a situation where they are moving in a synchronized fashion as would be the case if both are placed at the ears and a situation where they are moving mutually independently as would be the case during a phase of manipulation. When on the ears, the hearing aids can be expected to be oriented close to parallel, or, at least, to be oriented mutually rather consistently, whereas two hearing aids in a phase of manipulation would likely assume different attitudes, e.g. one still in the ear and the other one being twisted in a hand to get to a switch or button, enabling the processors to decide correctly whether the hearing aids are in a state of normal use or not.

Two Accelerometers Acting Together as a Gyro Sensor

One embodiment provides a system of two accelerometer-enabled hearing aids, for usage as right and left hearing aid, respectively, provided with inter-ear communication, e.g. by an inductive link, and adapted for combining the detections at right ear and left ear for establishing various motion patterns. When e.g. the hearing aid user turns his or her head, the left and the right hearing aid move in different directions. The difference can be used to detect rotation (yaw or roll), in order that the combination can provide a gyroscope capability by utilizing just a plain accelerometer in each hearing aid. When e.g. turning the head (yaw), one hearing aid will move forward, and the other will move backward. Similarly, when tilting the head to the side (roll), one hearing aid will move upwards and the other one downwards.

The processor comprises a decision logic referred to as the the state detection engine, which establishes various states of current conditions, progressing through steps of operation as described in the following.

Main states of motion encountered by the hearing aid in normal life:

a) Rest (non-usage)
b) Normal usage, at the ear of the user
c) Being manipulated

Transition between states (a) and (b) must step through the state (c), i.e. a->c->b or b->c->a.

Functional requirements tied to the respective states:
a) Power is off
b) Power is on, hearing aid operates normally
c) Power is on, hearing aid is preferably muted

Functional requirements tied to transitions between the respective states:
a->c->b: Having completed the transition to state (b), the hearing aid conducts a start-up test and plays a welcome message. The hearing aid preferably remains muted until the welcome message plays, and then enters normal operation
b->c->a: The hearing is preferably muted from the instant removal from the ear has commenced

Indicators of state detectable by accelerometer:

a) Rest. The hearing aid is lying dead-still. This condition is established by default if not qualifying for (b) or (c)

b) At the ear. In general, whenever a human is wearing an object, that human makes small motions. Therefore there will be some motion, though it may be slow and confined to within a range of attitudes. The condition (b) is established if not qualifying for (c), and if the hearing aid nevertheless exhibits some level of motion

c) Hearing aid being manipulated. The motion can be faster than at (b), the hearing aid panning through a wide range of attitudes, some of them not germane to normal usage, like upside-down, or on one side. The hearing aids of a pair move mutually independently. A condition of manipulation is maintained by a timer (manipulation timer) for a predefined time interval, e.g. 2 s, to bridge moments of non-motion and avoid erratic changes. Specific trip points for declaring a condition of manipulation can be
1) an attitude deviating more than 90° from the normal usage position,
2) a linear acceleration exceeding 3 g (g is the acceleration due to the force of gravity, 9.81 m/s²)
3) rotation (yaw, pitch or roll) at an angular rate exceeding 6 rad/s, or
4) any combination of the above

Embodiment with Manual on/Off Switching

The phases:
a) The hearing aid is picked up, and the user flips the power switch on. The hearing aid processor powers up but keeps the sound output muted. The accelerometer tracks the motion and establishes a condition of manipulation.
b) The hearing aid is manipulated for being placed at the ear with the sound output opening being entered into the mouth of the ear canal. The hearing aid remains muted for the duration of the condition of manipulation.
c) The manipulation ends once the hearing has reached its place of operation. The accelerometer senses that motion has settled down to a low level. Once the manipulation timer has expired without renewed signs of manipulation, a condition of normal use is declared. Entry into the condition of normal use prompts the hearing aid to launch a start-up procedure which encompasses a start-up test, e.g. comprising verifying the seat of the ear plug, and verifying the operation of the processor, potentially including the feedback canceller, and of the transducer. If the verification is successful, the hearing plays a welcome message and then enters normal operation. Depending on the result of the verification, the hearing aid may also play particular messages to the user, e.g. “Please verify that the hearing aid is correctly inserted into the ear canal”, “Please change wax guard”, etc.
d) During normal usage, the hearing aid periodically checks for signs of manipulation, and, if the occasion arises, reverts to the condition of manipulation as explained at item b above. This entails that the hearing aid mutes.
e) Removal. Behavior as at (b) until the user flips the power switch off.

Embodiment with Automatic on/Off Switching

The phases:
a) The hearing aid is picked up. The accelerometer senses motion and triggers automatic power-on. The processors powers up, but keeps the sound output muted.
b) The hearing aid is manipulated for being placed at the ear with the sound output opening entered into the mouth of the ear canal. The hearing aid stays muted.
c) The hearing reaches its place of operation. The accelerometer senses that motion settles down to a lower level.
d) Once the manipulation timer has expired without renewed signs of manipulation, a condition of normal use is declared. Entry into the condition of normal use prompts the hearing aid to launch a start-up procedure as in the embodiment enumerated above.
e) During normal usage, the hearing aid periodically checks for signs of manipulation, and, if the occasion arises, reverts to the condition of manipulation as explained at item b above and proceeds from there.
f) During normal operation, the accelerometer periodically checks whether the hearing aid stays completely immobile for a predetermined period of time. If so, the processor powers off. The thresholds for establishing a state of normal usage will be set below those for establishing a state of manipulation, and above the sensor noise floor. The power-off circuit may also include filtering to ensure that only sustained motion, e.g. over 10 s, will be recognized as activity. The timer for power off (sleep timer) can be set for a longer interval of time than is the manipulation timer, as prompt response is less critical for the power-off function.
g) Power-off mode. The accelerometer “sniffs” periodically for signs of motion. The adaptation of the sniffing intervals is a trade off between response time for powering off and current consumption. Generally a few measurements per second suffice to enable the hearing aid to power down without noticeable delay.

We claim:

1. A hearing aid comprising a housing, a processor and an inertial measurement unit, wherein the processor is adapted to utilize the output from the inertial measurement unit to derive information about at least one of motion, tilt, and posture.

2. The hearing aid according to claim 1, wherein the hearing aid is adapted to operate in a normal mode and a power-down mode, where the hearing aid in power-down mode operates the inertial measurement unit and circuitry to process information from the inertial measurement unit, and wherein the processor is adapted to utilize information about motion to establish whether the user is or is not wearing the hearing aid, to respond to establishing that the user is not wearing the hearing aid by entering the power-down mode, and to respond to establishing that the user is wearing the hearing aid by entering normal mode.

3. The hearing aid according to claim 2, wherein the processor is adapted to establish whether the user is or is not wearing the hearing aid by checking whether the hearing aid is lying down on one side.

4. The hearing aid according to claim 2, wherein the circuitry to process information is divided into subsections which can be selectively powered down, and wherein the circuitry to process information from the inertial measurement unit is placed in a subsection of the processor adapted to remain powered while other subsections can be turned off.

5. A hearing aid comprising a processor and an inertial measurement unit, wherein the inertial measurement unit is adapted to determine whether the hearing aid is in a phase of being removed, inserted or otherwise not being placed in the ear, in order that the processor can act to suppress the gain, turn down the receiver, or turn down the microphone to prevent a howling effect.

6. The hearing aid according to claim 5, wherein the inertial measurement unit is adapted to establish the phase of being removed, inserted or otherwise not being placed in the ear by sensing an attitude deviating more than 90° from the normal use attitude.

7. The hearing aid according to claim 5, wherein the inertial measurement unit is adapted to establish the phase of being removed, inserted or otherwise not being placed in the ear by sensing a linear acceleration exceeding 3 g.

8. The hearing aid according to claim 5, wherein the inertial measurement unit is adapted to establish the phase of being removed, inserted or otherwise not being placed in the ear by sensing rotation at an angular rate exceeding 6 rad/s.

9. A hearing aid system, comprising a left hearing aid, a right hearing aid, an external device, and link means for communication between the hearing aids and the external device, each hearing aid having a respective housing, a respective processor and a respective inertial measurement unit, wherein the link means enables the exchange of data from the respective inertial measurement units between the two hearing aids and with the external device, wherein at least one of the two hearing aids and the external device comprises software to establish whether the motions by the hearing aids are synchronous as if they are placed in the normal use position at the head, thereby to establish a condition of normal usage.

10. A method of deriving information about at least one of motion, tilt, or posture, comprising incorporating in the hearing aid housing a processor and an inertial measurement unit, and using the output from the inertial measurement unit to derive the information.

11. The method according to claim 10, comprising adapting the hearing aid to operate in a normal mode and a power-down mode, where the hearing aid in power-down mode operates the inertial measurement unit and circuitry to process information from the inertial measurement unit, and adapting the processor to utilize information about motion to establish whether the user is or is not wearing the hearing aid, to respond to establishing that the user is not wearing the hearing aid by entering the power-down mode, and to respond to establishing the user is wearing the hearing aid by entering normal mode.

12. The method according to claim 10, comprising establishing whether the hearing aid is in a phase of being removed, inserted or otherwise not being placed in the ear, and in the affirmative muting the hearing aid output.
